(19) United States
(12) Patent Application Publication
(10) Pub. No.: US 2008/0152835 A1
(43) Pub. Date: Jun. 26, 2008

(54) Method for Patterning a Surface

(75) Inventors: Brian T. Mayers, Somerville, MA (US); Jeffrey Carbeck, Belmont, MA (US); Wajeeh Saadi, Cambridge, MA (US); George M. Whitesides, Newton, MA (US); Ralf Kugler, Ludwigshafen (DE); Monika Kursawe, Seeheim-Jugenheim (DE); Johannes Canisius, Hampshire (GB)

Correspondence Address: STERNE, KESSLER, GOLDSTEIN & FOX P.L.L.C., 1100 NEW YORK AVENUE, N.W., WASHINGTON, DC, 20005, US

(73) Assignees: Nano Terra Inc., Cambridge, MA (US); Merck KGaA, Darmstadt (DE)

(21) Appl. No.: 11/950,703

(22) Filed: Dec. 5, 2007

Related U.S. Application Data
(60) Provisional application No. 60/872,802, filed on Dec. 5, 2006.

(51) Int. Cl. B29C 71/04; B05D 5/00; B05D 1/32

(52) U.S. Cl. 427/532; 427/256; 427/282

(57) ABSTRACT

The present invention is directed to methods for patterning surfaces using contact printing and pastes, pastes for use with the processes, and products formed therefrom.

### CROSS REFERENCE TO RELATED APPLICATIONS

This application claims the benefit of the filing date of U.S. Patent Application No. 60/872,802, filed Dec. 5, 2006, which is incorporated herein by reference in its entirety.

### BACKGROUND OF THE INVENTION

1. Field of the Invention

The present invention is directed to methods for patterning a surface using contact printing processes that employ a stamp or an elastomeric stencil and a paste.

2. Background

Methods of patterning surfaces are well known and include photolithography techniques, as well as the more recently developed soft-contact printing techniques such as “micro-contact printing” (see, e.g., U.S. Pat. No. 5,512,131).

Traditional photolithography methods, while versatile in the architectures and compositions of surface features to be formed, are also costly and require specialized equipment. Moreover, photolithography techniques have difficulty patterning very large and/or non-rigid surfaces such as, for example, textiles, paper, plastics, and the like.

Soft-lithographic techniques have demonstrated the ability to produce surface features having lateral dimension as small as 40 nm or less in a cost-effective, reproducible manner. However, the range of surface features that can be formed using these techniques is somewhat limited.

Pastes have been used in the art to form a variety of surface features having complex architectures. Typically, pastes are applied to surfaces by screen printing, spraying, ink-jet printing, or syringe deposition. However, the lateral dimensions of surface features produced by these methods are somewhat limited.

What is needed is a contact printing technique that can achieve lateral dimensions below 100 μm.

### BRIEF SUMMARY OF THE INVENTION

The present invention is directed to patterning substrates using contact-printing techniques that employ pastes and other compositions as inks for forming features on the substrates. Surface features formed by the method of the present invention have lateral dimensions less than 100 μm, and permit all varieties of surfaces to be patterned in a cost-effective, efficient, and reproducible manner.

The present invention is directed to a method for forming a feature on a substrate, the method comprising:
(a) providing a stamp having a surface including at least one indentation therein, the indentation being contiguous with and defining a pattern in the surface of the stamp;
(b) applying a paste to the surface of the stamp to provide a coated stamp;
(c) contacting the surface of the coated stamp with a substrate to adhere the paste to an area of the substrate; and
(d) reacting the paste adhered to the area of the substrate to produce a feature on the substrate;
   wherein the pattern on the surface of the stamp defines a lateral dimension of the surface feature, and wherein the lateral dimension of the surface feature is about 40 nm to about 100 μm.

The present invention is directed to a method for forming a feature on a substrate, the method comprising:
(a) providing an elastomeric stamp having a surface including at least one indentation therein, the indentation being contiguous with and defining a pattern in the surface of the elastomeric stamp;
(b) applying an ink to the surface of the elastomeric stamp to form a coated elastomeric stamp;
(c) contacting the surface of the coated elastomeric stamp with a substrate for an amount of time sufficient to transfer the ink from the surface of the elastomeric stamp to an area of a substrate in a pattern defined by the pattern in the surface of the elastomeric stamp;
(c) removing the elastomeric stamp from the substrate;
(d) applying a paste to an area of the substrate not coated by the pattern of ink; and
(e) reacting the paste with the area of the substrate not coated by the pattern of ink to produce a feature on the substrate;
   wherein the pattern of the ink defines a lateral dimension of the surface feature, and
   wherein the lateral dimension of the surface feature is about 40 nm to about 100 μm.

The present invention is directed to a method for forming a feature on a substrate, the method comprising:
(a) applying a paste to a substrate to form a coated substrate;
(b) providing a stamp having a surface including at least one indentation therein, the indentation being contiguous with and defining a pattern in the surface of the stamp;
(c) contacting the surface of the stamp with an area of the coated substrate to produce a pattern of paste on the substrate defined by the pattern in the surface of the stamp; and
(d) reacting the paste to produce a feature on the substrate;
   wherein the pattern in the surface of the stamp defines a lateral dimension of surface feature, and wherein the lateral dimension of the surface feature is about 40 nm to about 100 μm.

The present invention is directed to a method for forming a feature on a substrate, the method comprising:
(a) providing an elastomeric stencil having a surface with an opening therein;
(b) contacting the surface of the elastomeric stencil with a substrate, wherein the opening in the elastomeric stencil exposes an area of the substrate;
(c) applying a paste to the exposed area of the substrate; and
(d) reacting the paste applied to the exposed area of the substrate to produce a feature on the substrate;
   wherein the lateral dimension of the opening in the elastomeric stencil defines a lateral dimension of the surface feature produced by reacting the paste, and wherein the lateral dimension of the surface feature is about 40 nm to about 100 μm.

In some embodiments, the area of the substrate onto which the paste is adhered is in contact with the surface of the stamp. In some embodiments, the area of the substrate onto which the paste is adhered is in conformal contact with the surface of the stamp. In some embodiments, the area of the substrate onto which the paste is adhered is in contact with the at least one indentation in the surface of the stamp. In some embodiments, the area of the substrate onto which a pattern of ink is adhered was in contact with the surface of the elastomeric stamp. In some embodiments, the area of the substrate onto which a pattern of ink adheres is in conformal contact with the surface of the elastomeric stamp.

In some embodiments, the method further comprises pre-treating at least one of the stamp and the substrate with a process chosen from: cleaning, oxidizing, reducing, derivatizing, functionalizing, exposing to a reactive gas, exposing to a plasma, exposing to a thermal energy, exposing to an electromagnetic radiation, and combinations thereof.

In some embodiments, the stamp comprises an elastomeric polymer.

In some embodiments, contacting comprises placing at least one area of the surface of the stamp, the elastomeric stamp, or the elastomeric stencil in conformal contact with at least one area of the substrate.

In some embodiments, the contacting further comprises applying a pressure or a vacuum to a backside of the substrate, a backside of the elastomeric stamp, a backside of the elastomeric stencil, and combinations thereof.

In some embodiments, the contacting further comprises applying a pressure or a vacuum to at least one of a backside of the stamp, a backside of the substrate, and a backside of the stencil, wherein the pressure or vacuum is sufficient to move any paste that is present between the surface of the stamp and the substrate to either: an edge of the stamp, an indentation in the surface of the stamp, an edge of the stencil, an opening in the stencil, and combinations thereof.

In some embodiments, contacting further comprises applying pressure or vacuum to at least one of the backside of the elastomeric stencil or the backside of the substrate, wherein the pressure or vacuum is sufficient to prevent any paste from entering the space between the surface of the elastomeric stamp and the substrate.

In some embodiments, the method further comprises: before reacting the paste, removing the stamp or stencil from the substrate.

In some embodiments, the method further comprises: after reacting the paste, removing the stamp or stencil from the substrate.

In some embodiments, the applying further comprises: increasing the viscosity of the paste. In some embodiments, the reacting further comprises: decreasing the viscosity of the paste.

In some embodiments, the reacting comprises leaving the paste adhered to the substrate for a predetermined period of time. In some embodiments, the reacting comprises: penetrating or diffusing a component of the paste into the substrate, removing solvent from the paste, cross-linking one or more components within the paste, sintering metal particles within the paste, and combinations thereof.

In some embodiments, the reacting further comprises: exposing the paste to a reaction initiator chosen from: thermal energy, radiation, acoustic waves, a plasma, an electron beam, a stoichiometric chemical reagent, a catalytic chemical reagent, a reactive gas, an increase or decrease in pH, an increase or decrease in pressure, electrical current, agitation, friction, and combinations thereof.

Surface features produced by the method of the present invention include, but are not limited to, additive non-penetrating surface features, additive penetrating surface features, conformal non-penetrating surface features, conformal penetrating surface features, subtractive non-penetrating surface features, and subtractive penetrating surface features. In some embodiments, the surface feature is a subtractive non-penetrating surface feature.

In some embodiments, the feature on the substrate comprises a reactive species diffused into the substrate.

In some embodiments, the method of the present invention further comprises: after reacting the paste, etching an area of the surface onto which the paste is not adhered.

In some embodiments, the method of the present invention further comprises: after reacting the paste, removing the paste from the surface.

In some embodiments, the surface feature comprises at least one of a structural feature, a masking feature, a conductive feature, or an insulating feature.

Further embodiments, features, and advantages of the present inventions, as well as the structure and operation of the various embodiments of the present invention, are described in detail below with reference to the accompanying drawings.

### BRIEF DESCRIPTION OF THE DRAWINGS

The accompanying drawings, which are incorporated herein and form a part of the specification, illustrate one or more embodiments of the present invention and, together with the description, further serve to explain the principles of the invention and to enable a person skilled in the pertinent art to make and use the invention.

FIGS. 1A, 1B, 1C, 1D, 1E, 1F and 1G provide schematic cross-sectional representations of surface features prepared by a method of the present invention.

FIG. 2 provides a schematic cross-sectional representation of a curved substrate having features thereon prepared by a method of the present invention.

FIG. 3 provides an image of an indium tin oxide (ITO, thickness=30 nm) on glass (SiO₂) substrate having subtractive non-penetrating surface features produced by a method of the present invention, as described in Example 4.

FIG. 4 provides a graphical representation of an elevation profile of the subtractive non-penetrating features on a glass slide, as shown in FIG. 3.

FIG. 5 provides a graphical representation of a lateral profile of the subtractive non-penetrating features on an ITO on glass substrate, as shown in FIG. 3, as determined by optical profilometry.

FIG. 6 provides an image of a glass (SiO₂) substrate having subtractive non-penetrating surface features thereon produced by a method of the present invention, as described in Example 8.

FIG. 7 provides a graphical representation of an elevation profile of the subtractive non-penetrating features on a glass slide, as shown in FIG. 6.

FIG. 8 provides a graphical representation of a lateral profile of the subtractive non-penetrating features on a glass slide, as shown in FIG. 6, as determined by optical profilometry.

One or more embodiments of the present invention will now be described with reference to the accompanying drawings. In the drawings, like reference numbers can indicate identical or functionally similar elements. Additionally, the left-most digit(s) of a reference number can identify the drawing in which the reference number first appears.

### DETAILED DESCRIPTION OF THE INVENTION

This specification discloses one or more embodiments that incorporate the features of this invention. The disclosed embodiment(s) merely exemplify the invention. The scope of the invention is not limited to the disclosed embodiment(s). The invention is defined by the claims appended hereto.

The embodiment(s) described, and references in the specification to “one embodiment”, “an embodiment”, “an example embodiment”, etc., indicate that the embodiment(s) described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is understood that it is within the knowledge of one skilled in the art to effect such feature, structure, or characteristic in connection with other embodiments whether or not explicitly described.

### Surface Features

The present invention provides methods for forming a feature in or on a substrate. Substrates suitable for use with the present invention are not particularly limited by size, composition or geometry. For example, the present invention is suitable for patterning planar, curved, symmetric, and asymmetric objects and surfaces, and any combination thereof. Additionally, the substrate can be homogeneous or heterogeneous in composition. The methods are also not limited by surface roughness or surface waviness, and are equally applicable to smooth, rough and wavy surfaces, and substrates exhibiting heterogeneous surface morphology (i.e., substrates having varying degrees of smoothness, roughness and/or waviness).

As used herein, a “feature” refers to an area of a substrate that is contiguous with, and can be distinguished from, the areas of the substrate surrounding the feature. For example, a feature can be distinguished from the areas of the substrate surrounding the feature based upon the topography of the feature, composition of the feature, or another property of the surface feature that differs from the areas of the substrate surrounding the feature.

Features are defined by their physical dimensions. All features have at least one lateral dimension. As used herein, a “lateral dimension” refers to a dimension of a feature that lies in the plane of a surface. One or more lateral dimensions of a feature define, or can be used to define, the surface area of a substrate that a feature occupies. Typical lateral dimensions of features include, but are not limited to: length, width, radius, diameter, and combinations thereof.

All features have at least one dimension that can be described by a vector that lies out of the plane of a surface. As used herein, “elevation” refers to the largest vertical distance between the plane of a surface and the highest or lowest point on a surface feature. More generally, the elevation of an additive surface feature refers to its highest point relative to a plane of a substrate, the elevation of a subtractive surface feature refers to its lowest point relative to the plane of a substrate, and a conformal surface feature has an elevation of zero (i.e., is at the same height as the plane of the substrate).

A surface feature produced by a method of the present invention can generally be classified as: an additive feature, a conformal feature, or a subtractive feature, based upon the elevation of the surface feature relative to a plane of the substrate.

A surface feature produced by a method of the present invention can be further classified as: a penetrating surface feature or a non-penetrating surface feature, based upon whether or not the base of a surface feature penetrates below the plane of a substrate on which it is formed. As used herein, a “penetration distance” refers to the distance between the lowest point of a surface feature and the height of the substrate adjacent to the surface feature. More generally, the penetration distance of a surface feature refers to its lowest point relative to the plane of the substrate. Thus, a feature is said to be “penetrating” when its lowest point is located below the plane of the substrate on which the feature is located, and a feature is said to be “non-penetrating” when the lowest point of the feature is located within or above the plane of the substrate on which it is located. A non-penetrating surface feature can be said to have a penetration distance of zero.

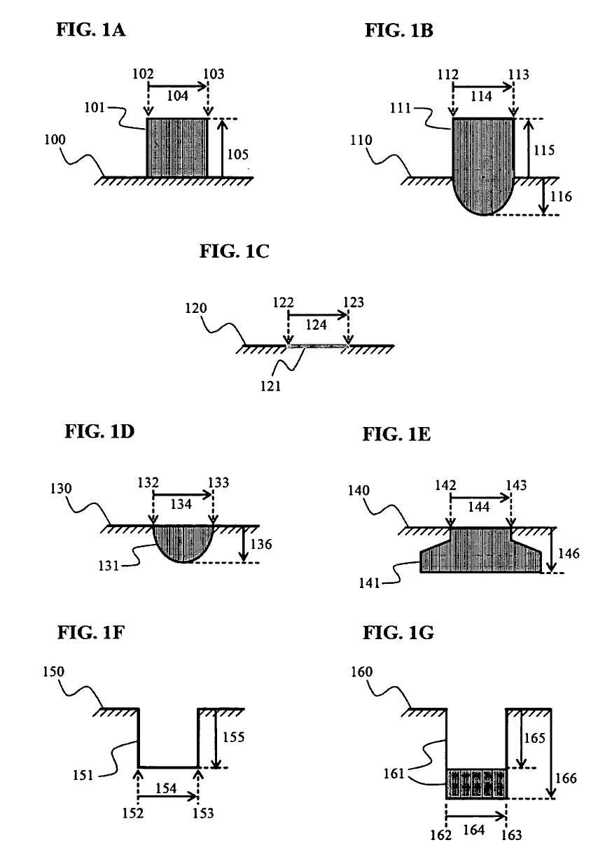

As used herein, an “additive feature” refers to a surface feature having an elevation that is above the plane of a substrate. Thus, the elevation of an additive feature is greater than the elevation of the surrounding substrate. FIG. 1A shows a cross-sectional schematic representation of a substrate, 100, having an “additive non-penetrating” surface feature, 101. The surface feature, 101, has a lateral dimension, 104, an elevation, 105, and a penetration distance of zero. FIG. 1B shows a cross-sectional schematic representation of a substrate, 110, having an “additive penetrating” surface feature, 111. The surface feature, 111, has a lateral dimension, 114, an elevation, 115, and a penetration distance, 116.

As used herein, a “conformal feature” refers to a surface feature having an elevation that is even with a plane of the substrate on which the feature is located. Thus, a conformal feature has substantially the same topography as the surrounding substrate. As used herein, a “conformal non-penetrating” surface feature refers to a surface feature that is purely on the surface of a substrate. For example, a paste that reacts with the exposed functional groups of a substrate such as, for example, by oxidizing, reducing, or functionalizing the substrate, would form a conformal non-penetrating surface feature. FIG. 1C shows a cross-sectional schematic representation of a substrate, 120, having a “conformal non-penetrating” surface feature, 121. The surface feature, 121, has a lateral dimension, 124, and has an elevation of zero and a penetration distance of zero. FIG. 1D shows a cross-sectional schematic representation of a substrate, 130, having a “conformal penetrating” surface feature, 131, The surface feature, 131, has a lateral dimension, 134, an elevation of zero, and penetration distance, 136. FIG. 1E shows a cross-sectional schematic representation of a substrate, 140, having a “conformal penetrating” surface feature, 141, The surface feature, 141, has a lateral dimension, 144, an elevation of zero, and penetration distance, 146.

As used herein, a “subtractive feature” refers to a surface feature having an elevation that is below the plane of the surface. FIG. 1F shows a cross-sectional schematic representation of a substrate, 150, having a “subtractive non-penetrating” surface feature, 151. The surface feature, 151, has a lateral dimension, 154, an elevation, 155, and penetration distance of zero. FIG. 1G shows a cross-sectional schematic representation of a substrate, 160, having a “subtractive penetrating” surface feature, 161. The surface feature, 161, has a lateral dimension, 164, an elevation, 165, and a penetration distance, 166.

Surface features can be further differentiated based upon their composition and utility. For example, surface features produced by a method of the present invention include structural surface features, conductive surface features, semi-conductive surface features, insulating surface features, and masking surface features.

As used herein, a “structural feature” refers to surface feature having a composition similar or identical to the composition of the substrate on which the surface feature is located.

As used herein, a “conductive feature” refers to a surface feature having a composition that is electrically conductive, or electrically semi-conductive. Electrically semi-conductive features include surface features whose electrical conductivity can be modified based upon an external stimulus such as, but not limited to, an electrical field, a magnetic field, a temperature change, a pressure change, exposure to radiation, and combinations thereof.

As used herein, an “insulating feature” refers to a surface feature having a composition that is electrically insulating.

As used herein, a “masking feature” refers to a surface feature that has composition that is inert to reaction with a reagent that is reactive towards an area of the substrate adjacent to and surrounding the surface feature. Thus, a masking feature can be used to protect an area of a substrate during subsequent process steps, such as, but not limited to, etching, deposition, implantation, and surface treatment steps. In some embodiments, a masking feature is removed during or after subsequent process steps.

### Feature Size and Measurement

A surface feature produced by a method of the present invention has lateral and vertical dimensions that are typically defined in units of length, such as angstroms (Å), nanometers (nm), microns (μm), millimeters (mm), centimeters (cm), etc.

When an area of the surface of a substrate surrounding a feature thereon is planar, a lateral dimension of a surface feature can be determined by the magnitude of a vector between two points located on opposite sides of a surface feature, wherein the two points are in the plane of the substrate and wherein the vector is parallel to the plane of the substrate. In some embodiments, two points used to determine a lateral dimension of a symmetric surface feature also lie on a mirror plane of the symmetric feature. In some embodiments, a lateral dimension of an asymmetric surface feature can be determined by aligning a vector orthogonally to at least one edge of the surface feature.

For example, in FIGS. 1A-1G points lying in the plane of the substrate and on opposite sides of the surface features, 101, 111, 121, 131, 141, 151 and 161, are shown by dashed arrows, 102 and 103; 112 and 113; 122 and 123; 132 and 133; 142 and 143; 152 and 153, and 162 and 163, respectively. The lateral dimension of these surface features is shown by the magnitude of the vectors 104, 114, 124, 134, 144, 154 and 164, respectively.

A surface of a substrate is “curved” when the radius of curvature of a substrate surface is non-zero over a distance on the surface of the substrate of 100 μm or more, or over a distance on the surface of the substrate of 1 mm or more. For a curved substrate, a lateral dimension is defined as the magnitude of a segment of the circumference of a circle connecting two points on opposite sides of the surface feature, wherein the circle has a radius equal to the radius of curvature of the substrate. A lateral dimension of a substrate having a curved surface having multiple or undulating curvature, or waviness, can be determined by summing the magnitude of segments from multiple circles.

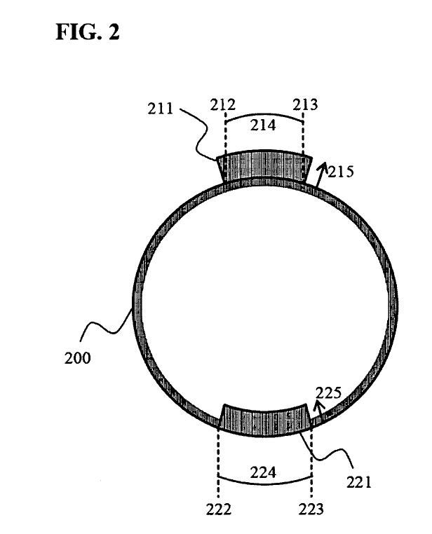

FIG. 2 displays a cross-sectional schematic of a substrate having a curved surface, 200, having an additive non-penetrating surface feature, 211, and a conformal penetrating surface feature, 221. A lateral dimension of the additive non-penetrating surface feature, 211, is equivalent to the length of the line segment, 214, which can connect points 212 and 213. Similarly, a lateral dimension of the conformal penetrating surface feature, 221, is equivalent to the length of the line segment, 224, which connect points 222 and 223.

In some embodiments, a surface feature produced by a method of the present invention has at least one lateral dimension of about 40 nm to about 100 μm. In some embodiments, a surface feature produced by a method of the present invention has at least one lateral dimension having a minimum size of about 40 nm, about 50 nm, about 60 nm, about 70 nm, about 80 nm, about 100 nm, about 150 nm, about 200 nm, about 250 nm, about 300 nm, about 400 nm, about 500 nm, about 600 nm, about 700 nm, about 800 nm, about 900 nm, about 1 μm, about 2 μm, about 3 μm, about 4 μm, about 5 μm, about 10 μm, about 15 μm, or about 20 μm. In some embodiments, a surface feature produced by a method of the present invention has at least one lateral dimension having a maximum size of about 100 μm, about 90 μm, about 80 μm, about 70 μm, about 60 μm, about 50 μm, about 40 μm, about 35 μm, about 30 μm, about 25 μm, about 20 μm, about 15 μm, about 10 μm, about 5 μm, about 2 μm, or about 1 μm.

In some embodiments, a feature produced by a method of the present invention has an elevation or penetration distance of about 3 Å to about 100 μm. In some embodiments, a surface feature produced by a method of the present invention has a minimum elevation or penetration distance of about 3 Å, about 5 Å, about 8 Å, about 1 nm, about 2 nm, about 5 nm, about 10 nm, about 15 nm, about 20 nm, about 30 nm, about 50 nm, about 100 nm, about 500 nm, about 1 μm, about 2 μm, about 5 μm, about 10 μm, or about 20 μm above or below the plane of a surface. In some embodiments, a surface feature produced by a method of the present invention has a maximum elevation or penetration distance of about 100 μm, about 90 μm, about 80 μm, about 70 μm, about 60 μm, about 50 μm, about 40 μm, about 30 μm, about 20 μm, about 10 μm, or about 5 μm above or below the plane of a surface.

In some embodiments, a surface feature produced by a method of the present invention has an aspect ratio (i.e., a ratio of either one or both of the elevation and/or penetration distance to a lateral dimension) of about 1,000:1 to about 1:100,000, about 100:1 to about 1:100, about 80:1 to about 1:80, about 50:1 to about 1:50, about 20:1 to about 1:20, about 15:1 to about 1:15, about 10:1 to about 1:10, about 8:1 to about 1:8, about 5:1 to about 1:5, about 2:1 to about 1:2, or about 1:1.

A lateral and/or vertical dimension of an additive or subtractive surface feature can be determined using an analytical method that can measure surface topography such as, for example, scanning mode atomic force microscopy (AFM) or profilometry. Conformal surface features cannot typically be detected by profilometry methods. However, if the surface of a conformal surface feature is terminated with a functional group whose polarity differs from that of the surrounding surface areas, a lateral dimension of the surface feature can be determined using, for example, tapping mode AFM, functionalized AFM, or scanning probe microscopy.

Surface features can also be identified based upon a property such as, but not limited to, conductivity, resistivity, density, permeability, porosity, hardness, and combinations thereof using, for example, scanning probe microscopy.

In some embodiments, a surface feature can be differentiated from the surrounding surface area using, for example, scanning electron microscopy or transmission electron microscopy.

In some embodiments, a surface feature has a different composition or morphology compared to the surrounding surface area. Thus, surface analytical methods can be employed to determine both the composition of the surface feature, as well as the lateral dimension of the surface feature. Analytical methods suitable for determining the composition and lateral and vertical dimensions of a surface feature include, but are not limited to, Auger electron spectroscopy, energy dispersive x-ray spectroscopy, micro-Fourier transform infrared spectroscopy, particle induced x-ray emission, Raman spectroscopy, x-ray diffraction, x-ray fluorescence, laser ablation inductively coupled plasma mass spectrometry, Rutherford backscattering spectrometry/Hydrogen forward scattering, secondary ion mass spectrometry, time-of-flight secondary ion mass spectrometry, x-ray photoelectron spectroscopy, and combinations thereof.

### Paste Compositions

As used herein, a “paste” refers to a heterogeneous composition having a viscosity of about 1 centiPoise (cP) to about 10,000 cP. A “heterogeneous composition” refers to a composition having more than one excipient or component. As used herein, “paste” can also refer to a gel, a cream, a glue, an adhesive, and any other viscous liquid or semi-solid. In some embodiments, a paste for use with the present invention has a tunable viscosity, and/or a viscosity that can be controlled by one or more external conditions.

In some embodiments, a paste for use with the present invention has a viscosity of about 1 cP to about 10,000 cP. In some embodiments, a paste for use with the present invention has a minimum viscosity of about 1 cP, about 2 cP, about 5 cP, about 10 cP, about 15 cP, about 20 cP, about 25 cP, about 30 cP, about 40 cP, about 50 cP, about 60 cP, about 75 cP, about 100 cP, about 125 cP, about 150 cP, about 175 cP, about 200 cP, about 250 cP, about 300 cP, about 400 cP, about 500 cP, about 750 cP, about 1,000 cP, about 1,250 cP, about 1,500 cP, or about 2,000 cP. In some embodiments, a paste for use with the present invention has a maximum viscosity of about 10,000 cP, about 9,500 cP, about 9,000 cP, about 8,500 cP, about 8,000 cP, about 7,500 cP, about 7,000 cP, about 6,500 cP, about 6,000 cP, about 5,500 cP, about 5,000 cP, about 4,000 cP, about 3,000 cP, about 2,000 cP, about 1,000 cP, about 500 cP, about 250 cP, about 100 cP, or about 50 cP.

In some embodiments, the viscosity of a paste can be controlled. Parameters that can control viscosity of a paste include, but are not limited to, the average length, molecular weight, and/or degree of cross-linking of a copolymer; as well as the presence of a solvent and a concentration of a solvent; the presence of the a thickener (i.e., a viscosity-modifying component) and a concentration of a thickener; a particle size of a component present in the paste; the free volume (i.e., porosity) of a component present in the paste; the swellability of a component present in the paste; an ionic interaction between oppositely charged and/or partially charged species present in the paste (e.g., a solvent-thickener interaction); and combinations thereof.

In some embodiments, a paste suitable for use with the present invention comprises a solvent and a thickening agent. In some embodiments, the combination of a solvent and a thickening agent can be selected to adjust the viscosity of a paste. Not being bound by any particular theory, the viscosity of a paste can be an important parameter for producing surface features having a lateral dimension of about 40 nm to about 100 μm.

Thickening agents suitable for use with a paste of the present invention include, but are not limited to, metal salts of carboxyalkylcellulose derivatives (e.g., sodium carboxymethylcellulose), alkylcellulose derivatives (e.g., methylcellulose and ethylcellulose), partially oxidized alkylcellulose derivatives (e.g., hydroxyethylcellulose, hydroxypropylcellulose and hydroxypropylmethylcellulose), starches, polyacrylamide gels, homopolymers of poly-N-vinylpyrrolidone, poly(alkyl ethers) (e.g., polyethylene oxide and polypropylene oxide), agar, agarose, xanthan gums, gelatin, dendrimers, colloidal silicon dioxide, and combinations thereof. In some embodiments, a thickener is present in a paste in a concentration of about 0.1% to about 50%, about 0.5% to about 25%, about 1% to about 20%, or about 5% to about 15% by weight of the paste.

In some embodiments, as the lateral dimensions of the desired surface features decrease it can be necessary to reduce the particle size or physical length of components in the paste. For example, for surface features having a lateral dimension of about 100 nm or less it can be necessary to reduce or eliminate polymeric components from a paste composition.

In some embodiments, a paste further comprises a solvent. Solvents suitable for use in a paste of the present invention include, but are not limited to, water, C₁-C₈ alcohols (e.g., methanol, ethanol, propanol and butanol), C₆-C₁₂ straight chain, branched and cyclic hydrocarbons (e.g., hexane and cyclohexane), C₆-C₁₄ aryl and aralkyl hydrocarbons (e.g., benzene and toluene), C₃-C₁₀ alkyl ketones (e.g., acetone), C₃-C₁₀ esters (e.g., ethyl acetate), C₄-C₁₀ alkyl ethers, and combinations thereof. In some embodiments, a solvent is present in a paste in a concentration of about 10% to about 99% by weight. In some embodiments, a solvent is present in a paste in a maximum concentration of about 99%, about 98%, about 97%, about 95%, about 90%, about 80%, about 70%, about 60%, about 50%, about 40%, or about 30% by weight of the paste. In some embodiments, a solvent is present in a minimum concentration of about 15%, about 20%, about 25%, about 30%, about 40%, about 50%, about 60%, about 70%, or about 80% by weight of the paste.

In some embodiments, a paste further comprises a surfactant. A surfactant present in a paste can modify the surface energy of a stamp and/or substrate to which the paste is applied, thereby improving the wetting of a surface by the paste. Surfactants suitable for use with the present invention include, but are not limited to, fluorocarbon surfactants that include an aliphatic fluorocarbon group (e.g., ZONYL® FSA and FSN fluorosurfactants, E.I. Du Pont de Nemours and Co., Wilmington, Del.), fluorinated alkyl alkoxylates (e.g., FLUORAD® surfactants, Minnesota Mining and Manufacturing Co., St. Paul, Minn.), hydrocarbon surfactants that have an aliphatic group (e.g., alkylphenol ethoxylates comprising an alkyl group having about 6 to about 12 carbon atoms, such as octylphenol ethoxylate, available as TRITON® X-100, Union. Carbide, Danbury, Conn.), silicone surfactants such as silanes and siloxanes (e.g., polyoxyethylene-modified polydimethylsiloxanes such as DOW CORNING® Q2-5211 and Q2-5212, Dow Corning Corp., Midland, Mich.), fluorinated silicone surfactants (e.g., fluorinated polysilanes such as LEVELENE® 100, Ecology Chemical Co., Watertown Mass.), and combinations thereof.

In some embodiments, a paste of the present invention further comprises an etchant. As used herein, an “etchant” refers to a component that can react with a substrate to remove a portion of the substrate. Thus, an etchant is used to form a subtractive feature, and in reacting with a substrate, forms at least one of a volatile material that can diffuse away from the substrate, or a residue, particulate, or fragment that can be removed from the substrate by, for example, a rinsing or cleaning process. In some embodiments, an etchant is present in a paste in a concentration of about 2% to about 80%, about 5% to about 75%, or about 10% to about 75% by weight of the paste.

The composition and/or morphology of a substrate that can react with an etchant is not particularly limited. Subtractive features formed by reacting an etchant with a substrate are also not particularly limited so long as the material that reacts with the etchant can be removed from the resulting subtractive surface feature. Not being bound by any particular theory, an etchant can remove material from a surface by reacting with the substrate to form a volatile product, a residue, a particulate, or a fragment that can, for example, be removed from the substrate by a rinsing or cleaning process. For example, in some embodiments an etchant can react with a metal or metal oxide surface to form a volatile fluorinated metal species. In some embodiments, an etchant can react with a substrate to form an ionic species that is water soluble. Additional processes suitable for removing a residue or particulate formed by reaction of an etchant with a surface are disclosed in U.S. Pat. No. 5,894,853, which is incorporated herein by reference in its entirety.

Etchants suitable for use with the present invention include, but are not limited to, an acidic etchant, a basic etchant, a fluoride-based etchant, and combinations thereof. Acidic etchants suitable for use with the present invention include, but are not limited to, sulfuric acid, trifluoromethanesulfonic acid, fluorosulfonic acid, trifluoroacetic acid, hydrofluoric acid, hydrochloric acid, carborane acid, and combinations thereof.

Basic etchants suitable for use with the present invention include, but are not limited to, sodium hydroxide, potassium hydroxide, ammonium hydroxide, tetraalkylammonium hydroxide ammonia, ethanolamine, ethylenediamine, and combinations thereof.

Fluoride-based etchants suitable for use with the present invention include, but are not limited to, ammonium fluoride, lithium fluoride, sodium fluoride, potassium fluoride, rubidium fluoride, cesium fluoride, francium fluoride, antimony fluoride, calcium fluoride, ammonium tetrafluoroborate, potassium tetrafluoroborate, and combinations thereof.

Additional paste compositions containing an etchant that are suitable for use with the present invention are disclosed in U.S. Pat. Nos. 5,688,366 and 6,388,187; and U.S. Patent Appl. Pub. Nos. 2003/0160026; 2004/0063326; 2004/0110393; and 2005/0247674, which are herein incorporated by reference in their entirety.

In some embodiments, a paste further comprises a reactive component. As used herein, a “reactive component” refers to a compound or species that has a chemical interaction with a substrate. In some embodiments, a reactive compound penetrates or diffuses into a substrate from a surface of the substrate. In some embodiments, a reactive component transforms, binds, or promotes binding to exposed functional groups on the surface of a substrate. Reactive components can include, but are not limited to, ions, free radicals, metals, acids, bases, metal salts, organic reagents, and combinations thereof. In some embodiments, a reactive component is present in a paste in a concentration of about 1% to about 100% by weight of the paste.

In some embodiments, a paste further comprises a conductive component. As used herein, a “conductive component” refers to a compound or species that can transfer or move electrical charge. Conductive components suitable for use with the present invention include, but are not limited to, a metal, a nanoparticle, a polymer, a cream solder, a resin, and combinations thereof. In some embodiments, a conductive component is present in a paste in a concentration of about 1% to about 90% by weight.

Metals suitable for use with the present invention include, but are not limited to, a transition metal, aluminum, silicon, phosphorous, gallium, germanium, indium, tin, antimony, lead, bismuth, alloys thereof, and combinations thereof. In some embodiments, a metal is present as a nanoparticle (i.e., a particle having a diameter of 100 nm or less, or about 0.5 nm to about 100 nm). Nanoparticles suitable for use with the present invention can be homogeneous, multilayered, functionalized, and combinations thereof.

Conductive polymers suitable for use with the present invention include, but are not limited to, an arylene vinylene polymer, a polyphenylenevinylene, a polyacetylene, a polythiophene, a polyimidazole, and combinations thereof.

Pastes comprising conductive components suitable for use with the present invention are further disclosed in U.S. Pat. Nos. 5,504,015; 5,296,043; and 6,703,295 and U.S. Patent Appl. Pub. No. 2005/0115604, which are incorporated herein by reference in their entirety.

In some embodiments, a paste further comprises an insulating component. As used herein, an “insulating component” refers to a compound or species that is resistant to the movement or transfer of electrical charge. In some embodiments, an insulating component has a dielectric constant of about 1.5 to about 8 about 1.7 to about 5, about 1.8 to about 4, about 1.9 to about 3, about 2 to about 2.7, about 2.1 to about 2.5, about 8 to about 90, about 15 to about 85, about 20 to about 80, about 25 to about 75, or about 30 to about 70. Insulating components suitable for use with the present invention include, but are not limited to, a polymer, a metal oxide, a metal carbide, a metal nitride, monomeric precursors thereof, particles thereof, and combinations thereof. Suitable polymers include, but are not limited to, a polydimethylsiloxane, a silsesquioxane, a polyethylene, a polypropylene, and combinations thereof. In some embodiments, an insulating component is present in a paste in a concentration of about 1% to about 80% by weight.

In some embodiments, a paste further comprises a masking component. As used herein, a “masking component” refers to a compound or species that upon reacting forms a surface feature resistant to a species capable of reacting with the surrounding substrate. Masking components suitable for use with the present invention include materials commonly employed in traditional photolithography methods as “resists” (e.g., photoresists). Masking components suitable for use with the present invention include, but are not limited to, cross-linked aromatic and aliphatic polymers, non-conjugated aromatic polymers and copolymers, polyethers, polyesters, copolymers of C₁-C₈ alkyl methacrylates and acrylic acid, copolymers of paralyne, and combinations thereof. In some embodiments, a masking component is present in a paste in a concentration of about 5% to about 98% by weight of the paste.

In some embodiments, a paste comprises a conductive component and a reactive component. For example, a reactive component present in the paste can promote at least one of: penetration of a conductive component into a substrate, reaction between the conductive component and a substrate, adhesion between a conductive feature and a substrate, promoting electrical contact between a conductive feature and a substrate, and combinations thereof. Surface features formed by reacting this paste composition include conductive features chosen from: additive non-penetrating, additive penetrating, subtractive penetrating, and conformal penetrating surface features.

In some embodiments, a paste comprises an etchant and a conductive component, for example, that can be used to produce a subtractive surface feature having a conductive feature inset therein.

In some embodiments, a paste comprises an insulating component and a reactive component. For example, a reactive component present in the paste can promote at least one of: penetration of an insulating component into a substrate, reaction between the insulating component and a substrate, adhesion between an insulating feature and a substrate, promoting electrical contact between an insulating feature and a substrate, and combinations thereof. Surface features formed by reacting this paste composition include insulating features chosen from: additive non-penetrating, additive penetrating, subtractive penetrating, and conformal penetrating surface features.

In some embodiments, a paste comprises an etchant and an insulating component, for example, that can be used to produce a subtractive surface feature having an insulating feature inset therein.

In some embodiments, a paste comprises a conductive component and a masking component, for example, that can be used to produce electrically conductive masking features on a substrate.

### Substrates

Substrates suitable for patterning by the method of the present invention are not particularly limited, and include any material having a surface capable of being contacted with a stamp. Substrates suitable for patterning by the method of the present invention include, but are not limited to, metals, alloys, composites, crystalline materials, amorphous materials, conductors, semiconductors, optics, fibers, glasses, ceramics, zeolites, plastics, films, thin films, laminates, foils, plastics, polymers, minerals, biomaterials, living tissue, bone, and combinations thereof. In some embodiments, a substrate is selected from a porous variant of any of the above materials.

In some embodiments, a substrate to be patterned by a method of the present invention comprises a semiconductor such as, but not limited to: crystalline silicon, polycrystalline silicon, amorphous silicon, p-doped silicon, n-doped silicon, silicon oxide, silicon germanium, germanium, gallium arsenide, gallium arsenide phosphide, indium tin oxide, and combinations thereof.

In some embodiments, a substrate to be patterned by a method of the present invention comprises a glass such as, but not limited to, undoped silica glass (SiO₂), fluorinated silica glass, borosilicate glass, borophosphorosilicate glass, organosilicate glass, porous organosilicate glass, and combinations thereof.

In some embodiments, a substrate to be patterned by a method of the present invention comprises a ceramic such as, but not limited to, silicon carbide, hydrogenated silicon carbide, silicon nitride, silicon carbonitride, silicon oxynitride, silicon oxycarbide, and combinations thereof.

In some embodiments, a substrate to be patterned by a method of the present invention comprises a flexible substrate, such as, but not limited to: a plastic, a composite, a laminate, a thin film, a metal foil, and combinations thereof. In some embodiments, the flexible material can be patterned by the method of the present invention on a reel-to-reel manner.

The present invention contemplates optimizing the performance, efficiency, cost, and speed of the process steps by selecting pastes and substrates that are compatible with one another. For example, in some embodiments, a substrate can be selected based upon its optical transmission properties, thermal conductivity, electrical conductivity, and combinations thereof.

In some embodiments, a substrate is transparent to at least one type of radiation suitable for initiating a reaction of the paste on the substrate. For example, a substrate transparent to ultraviolet light can be used with a paste whose reaction can be initiated by ultraviolet light, which permits the reaction of a paste on the front-surface of a substrate to be initiated by illuminating a backside of the substrate with ultraviolet light.

### Stamps and Stencils

As used herein, a “stamp” refers to a three-dimensional object having on at least one surface of the stamp an indentation that defines a pattern. Stamps for use with the present invention are not particularly limited by geometry, and can be flat, curved, smooth, rough, wavy, and combinations thereof. In some embodiments, a stamp can have a three dimensional shape suitable for conformally contacting a substrate. In some embodiments, a stamp can comprise multiple patterned surfaces that comprise the same, or different patterns. In some embodiments, a stamp comprises a cylinder wherein one or more indentations in the curved face of the cylinder define a pattern. As the cylindrical stamp is rolled across a surface, the pattern is repeated. Paste or ink can be applied to a cylindrical stamp as it rotates. For stamps having multiple patterned surfaces: cleaning, applying, contacting, removing, and reacting steps can occur simultaneously on the different surfaces of the same stamp.

Stamps for use with the present invention are not particularly limited by materials, and can be prepared from materials such as, but not limited to, glass (e.g., quartz, sapphire, borosilicate glass), ceramics (e.g., metal carbides, metal nitrides, metal oxides), plastics, metals, and combinations thereof. In some embodiments, a stamp for use with the present invention comprises an elastomeric polymer.

As used herein, an “elastomeric stamp” refers to a molded three-dimensional object comprising an elastomeric polymer, and having on at least one surface of the stamp an indentation that defines a pattern. More generally, stamps comprising an elastomeric polymer are referred to as elastomeric stamps. As used herein, an “elastomeric stencil” refers to a molded three dimensional object comprising an elastomeric polymer, and having at least one opening that penetrates through two opposite surfaces of the stencil to form an opening in the surface of the three dimensional object. An elastomeric stamp or stencil can further comprise a stiff, flexible, porous, or woven backing material, or any other means of preventing deformation of the stamp or stencil when it is used during processes described herein. Similar to stamps, elastomeric stencils for use with the present invention are not particularly limited by geometry, and can be flat, curved, smooth, rough, wavy, and combinations thereof.

Elastomeric polymers suitable for use with the present invention include, but are not limited to, polydimethylsiloxane, polysilsesquioxane, polyisoprene, polybutadiene, polychloroprene, teflon, and combinations thereof. Other suitable materials and methods to prepare elastomeric stamps suitable for use with the present invention are disclosed in U.S. Pat. Nos. 5,512,131; 5,900,160; 6,180,239; and 6,776,094; and pending U.S. application Ser. No. 10/766,427, all of which are incorporated herein by reference in their entirety.

### Applying and Reacting the Paste

Pastes can be applied to a surface of a stamp or a surface of a substrate by methods known in the art such as, but not limited to, screen printing, ink jet printing, syringe deposition, spraying, spin coating, brushing, and combinations thereof, and other application methods known to persons of ordinary skill in the art of coating surfaces. In some embodiments, a paste is poured onto a surface of a stamp, and then a blade is moved transversely across the surface to ensure that the indentations in the stamp are completely and uniformly filled with the paste. The blade can also remove excess paste from the surface of a stamp. Applying a paste to a substrate or the surface of the stamp can comprise rotating the surface at about 100 revolutions per minute (rpm) to about 5,000 rpm, or about 1,000 rpm to about 3,000 rpm, while pouring or spraying the paste onto the rotating surface.

Preferably, a paste is applied to a stamp to completely and uniformly fill the at least one indentation in the surface of the stamp. Not being bound by any particular theory, as the lateral dimensions of the indentation in the stamp become smaller, the viscosity of the paste should be decreased to ensure that the pattern in the stamp is filled uniformly during the applying step. Non-uniform application of a paste to a stamp can result in a failure to correctly and reproducibly produce surface features having the desired lateral dimensions.

In some embodiments, the composition of a paste can be formulated to control its viscosity. Parameters that can control paste viscosity include, but are not limited to, solvent composition, solvent concentration, thickener composition, thickener concentration, particles size of a component, the molecular weight of a polymeric component, the degree of cross-linking of a polymeric component, the free volume (i.e., porosity) of a component, the swellability of a component, ionic interactions between paste components (e.g., solvent-thickener interactions), and combinations thereof.

In some embodiments, the viscosity of a paste is modified during one or more of an applying step, contacting step, reacting step, or combinations thereof. For example, the viscosity of a paste can be decreased while applying the paste to a surface of a stamp to ensure that indentations in the surface of a stamp are filled completely and uniformly. After contacting the coated stamp with a substrate, the viscosity of the paste can be increased to ensure that the lateral dimensions of the indentations in the stamp are transferred to the lateral dimensions of a surface feature formed on the substrate.

Not being bound by any particular theory, the viscosity of a paste can be controlled by an external stimulus such as temperature, pressure, pH, the presence or absence of a reactive species, electrical current, a magnetic field, and combinations thereof. For example, increasing the temperature of a paste will typically decrease its viscosity; and increasing the pressure applied to a paste will typically increase its viscosity.

The pH of a paste either increases or decreases the viscosity of a paste depending on the properties of one or more components in the paste, depending on the overall solubility of the component mixture as a function of pH. For example, an aqueous paste containing a weakly acidic polymer will typically have a decreased viscosity below the pKₐ of the polymer because the solubility of the polymer will increase below its pKₐ. However, if protonation of the polymer leads to an ionic interaction between the polymer and another component in the paste that decreases the solubility of the polymer, then the viscosity of the paste will likely increase. Careful selection of paste components permits paste viscosity to be controlled over a wide range of pH values.

Transfer of the paste from a surface of a stamp to a substrate can be promoted by one or more interactions between the paste and the surface of the stamp, between the paste and the substrate, between the surface of the stamp and the substrate, and combinations thereof that promote(s) adhesion of a paste to an area of a substrate. Not being bound by any particular theory, adhesion of a paste to a substrate can be promoted by gravity, a Van der Waals interaction, a covalent bond, an ionic interaction, a hydrogen bond, a hydrophilic interaction, a hydrophobic interaction, a magnetic interaction, and combinations thereof. Conversely, the minimization of these interactions between a paste and the surface of a stamp can facilitate transfer of the paste from the surface of the stamp to the substrate.

In some embodiments, contacting a stamp or elastomeric stencil with a surface of a material can be facilitated by the application of pressure or vacuum to the backside of either or both the stamp, stencil and surface. In some embodiments, the application of pressure or vacuum can ensure that a paste is substantially removed from between the surfaces of the stamp or stencil and material. In some embodiments, the application of pressure or vacuum can ensure that there is conformal contact between the surfaces. In some embodiments, the application of pressure or vacuum can minimize the presence of gas bubbles present between the surfaces of the stamp and the substrate, or gas bubbles present in an indentation in the surface of the stamp, or gas bubbles present in the paste prior to reacting the paste. Not being bound by any particular theory, the removal of gas bubbles can facilitate in the reproducible formation of surface features having lateral dimensions of 100 μm or less.

In some embodiments, the surface of a substrate and/or the surface of a stamp can be selectively patterned, functionalized, derivatized, textured, or otherwise pre-treated. As used herein, “pre-treating” refers to chemically or physically modifying a surface prior to applying or reacting a paste. Pre-treating can include, but is not limited to, cleaning, oxidizing, reducing, derivatizing, functionalizing, exposing to a reactive gas, exposing to a plasma, exposing to a thermal energy (e.g., convective thermal energy, radiant thermal energy, conductive thermal energy, and combinations thereof), exposing to an electromagnetic radiation (e.g., x-rays, ultraviolet light, visible light, infrared light, and combinations thereof), and combinations thereof. Not being bound by any particular theory, pre-treating a surface of a stamp and/or a substrate can increase or decrease an adhesive interaction between a paste and a surface, and facilitate the formation of surface features having a lateral dimension of about 100 μm or less.

For example, derivatizing a surface of a stamp and/or substrate with a polar functional group (e.g., oxidizing the surface) can promote the wetting of a surface by a hydrophilic paste and deter surface wetting by a hydrophobic paste. Moreover, hydrophobic and/or hydrophilic interactions can be used to prevent a paste from penetrating into the body of a stamp. For example, derivatizing the surface of a stamp with a fluorocarbon functional group can facilitate the transfer of a paste from the stamp to the surface of a material.

The method of the present invention produces surface features by reacting a paste with an area of a substrate. As used herein, “reacting” refers to initiating a chemical reaction comprising at least one of: reacting one or more components present in the paste with each other, reacting one or more components of a paste with a surface of a substrate, reacting one or more components of a paste with sub-surface region of a substrate, and combinations thereof.

In some embodiments, reacting comprises applying a paste to a substrate (i.e., a reaction is initiated upon contact between a paste and a surface of a substrate).

In some embodiments, reacting the paste comprises a chemical reaction between the paste and a functional group on the substrate, or a chemical reaction between the paste and a functional group below the surface of the substrate. Thus, methods of the present invention comprise reacting a paste or a component of a paste not only with a surface of a substrate, but also with a region of a substrate below its surface, thereby forming inset or inlaid features in a substrate. Not being bound by any particular theory, a component of a paste can react with a substrate by reacting on the surface of the substrate, or penetrating and/or diffusing into the substrate. In some embodiments, the penetration of a paste into the surface of a substrate can be facilitated by the application of physical pressure or vacuum to the backside of a stamp, stencil, substrate, or combinations thereof.

Reaction between a paste and a substrate can modify one or more properties of substrate, wherein the change in properties is localized to the portion of the substrate that reacts with the paste. For example, a reactive metal particle can penetrate into the surface of a substrate, and upon reacting with the substrate, modify its conductivity. In some embodiments, a reactive component can penetrate into the surface of a substrate and react selectively to increase the porosity of the substrate in the areas (volumes) where reaction occurs. In some embodiments, a reactive component can selectively react with a crystalline substrate to increase or decrease its volume, or change the interstitial spacing of a crystalline lattice.

In some embodiments, reacting a paste comprises chemically reacting a functional group on the surface of a substrate with a component of the paste. Not being bound by any particular theory, a paste containing a reactive component can also react with only the surface of a substrate (i.e., no penetration and reaction with a substrate occurs below its surface). In some embodiments, a patterning method wherein only the surface of a substrate is changed can be useful for subsequent self-aligned deposition reactions.

In some embodiments, reacting the paste with a substrate can comprise reactions that propagate into the plane (i.e., body) of a substrate, as well as reactions in the lateral plane of a surface of the substrate. For example, a reaction between an etchant and a substrate can comprise the etchant penetrating into the surface of the substrate (i.e., penetration orthogonal to the surface), such that the lateral dimensions of the lowest point of the surface feature are approximately equal to the dimensions of the feature at the surface of the substrate.

In some embodiments, etching reactions also occur laterally between a paste and a substrate, such that the lateral dimensions at the bottom of a surface feature are more narrow than the lateral dimensions of the feature at the plane of the surface. As used herein, “undercut” refers to situations when the lateral dimensions of a surface feature are greater than the lateral dimensions of a stamp used to apply a paste to form the surface feature. Typically, undercut is caused by reaction of an etchant or reactive species with a surface in a lateral dimension, and can lead to the formation of beveled edges on subtractive features.

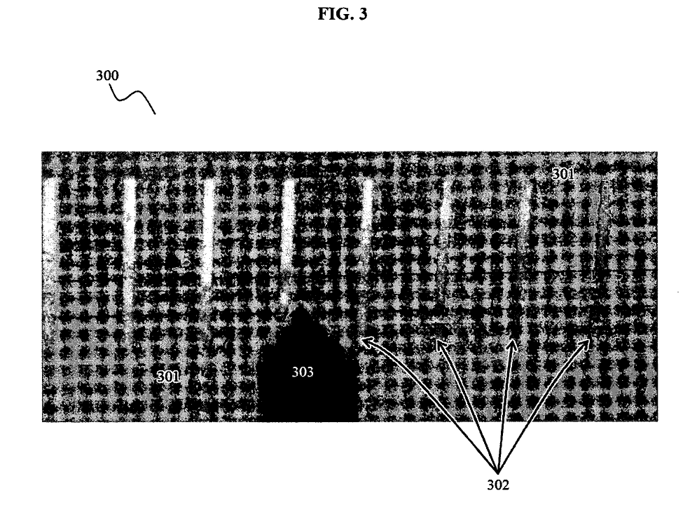

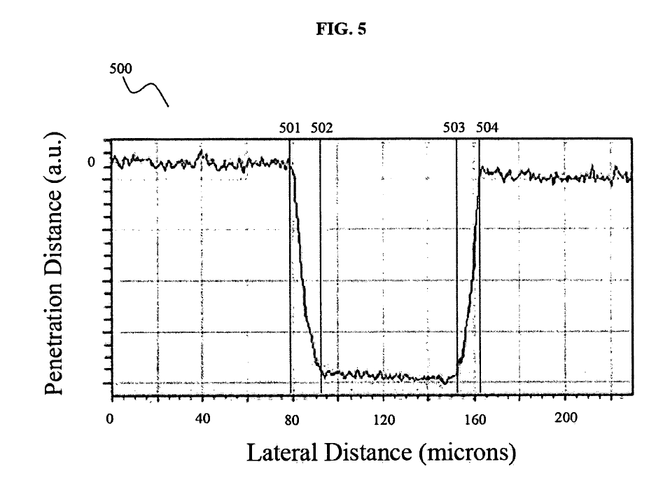

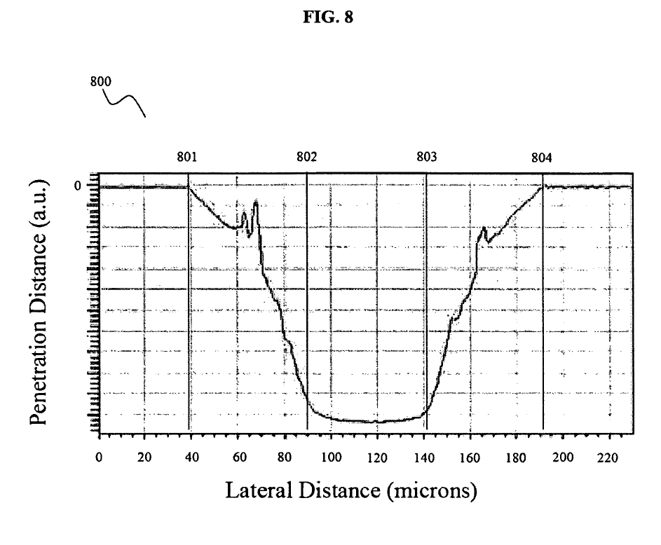

The surface features displayed in FIG. 5 and FIG. 8 show evidence of undercut. Referring to FIG. 5, portions of the substrate between lines 501 and 502, and lines 503 and 504, respectively, were removed due to a reaction of an etchant reacting laterally into the substrate. The surface features in both FIG. 5 and FIG. 8 were prepared using elastomeric stencils having openings of 50 μm. The surface features depicted in FIGS. 3-5 demonstrate the applicability of the method of the present invention to forming surface features having a lateral dimension of 100 μm or less.

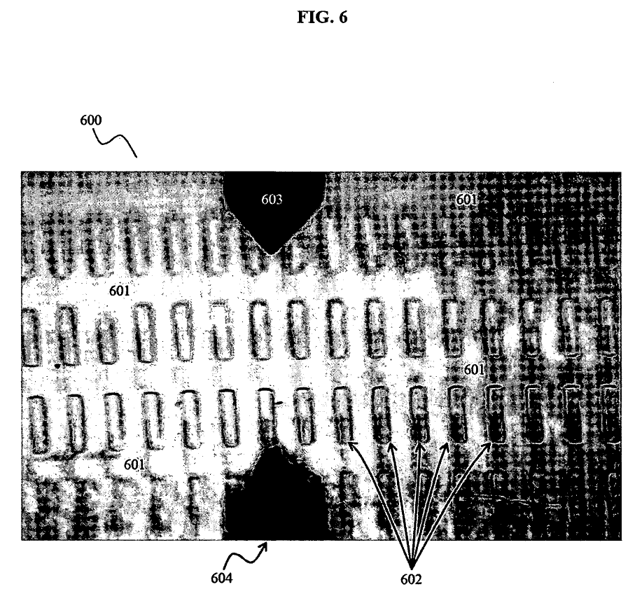

Comparing the undercut of the feature in FIG. 5 with that of FIG. 8, it is seen that the surface feature in FIG. 8 has a higher degree of undercut (about 50 μm, compared to about 10 μm for the feature in FIG. 5). However, the surface features shown in FIGS. 3-5 have a depth of about 30 nm, while the surface features in FIGS. 6-8 have a depth of about 6.8 μm (about 6,800 nm). Thus, a more accurate comparison of undercut for the etching paste/surface material combination used to produce these features (see Examples 5 and 8, respectively), would be to compare the etching rate in the lateral vs. vertical directions. The surface features in FIGS. 3-5 display about 10 μm of undercut occurred after etching about 30 nm of the material, to give a rate of 1 μm of undercut per 3 nm vertical etch. The surface features in FIGS. 6-8 show about 50 μm of undercut occur after etching about 6.8 μm of the material, to give a rate of 1 μm of undercut per 136 nm vertical etch. Thus, despite the higher amount of undercut shown in FIGS. 6-8, the selectivity of the etching paste in the vertical vs. lateral dimension is significantly better than that which produced the surface features shown in FIGS. 3-5. The combination of etching paste and surface material used in Example 8, would therefore permit a subtractive surface feature having a depth of 136 nm to be formed having an undercut of only 1 μm. Thus, the time of reaction is a parameter that can be selected to enable the formation of subtractive surface features having minimum undercut, and lateral dimensions identical to the lateral dimensions of a stamp or elastomeric stencil used to apply the paste to the surface.

In some embodiments, the paste compositions for use with the present invention are formulated to minimize the reaction of the paste in a lateral dimension of a surface (i.e., to minimize undercut). Not being bound by any particular theory, undercut can be minimized by employing a light-activated paste (i.e., a paste that reacts with a surface upon exposure to radiation). For example, an etching paste is applied to a glass surface that is transparent to UV light. Illumination of the paste through the backside of the glass surface initiates a reaction between the paste and the surface. Because the light illuminates only the surface of the paste reacting vertically with the surface, paste along the sidewalls of a subtractive surface feature is not exposed to ultraviolet light, thereby minimizing lateral etching of the surface. This technique is generally applicable to any reaction initiator that can be directed at the surface. In some embodiments, the reaction initiator can activate a paste through the backside of a stamp or elastomeric stencil.

Undercut can also be minimized by the use of a substrate having an anisotropic composition or structure, such that etching in the vertical direction is preferred compared to etching in a lateral dimension. Some materials are naturally anisotropic, while anisotropy can also be introduced by, for example, pre-treating a substrate with a chemical or radiation, and combinations thereof.

In some embodiments, reacting the paste comprises removing solvent from the paste. Not being bound by any particular theory, the removal of solvent from a paste can solidify the paste, or catalyze cross-linking reactions between components of a paste. For pastes containing solvents with a low boiling point (e.g., b.p. <60° C.), the solvent can be removed without heating of a surface. Solvent removal can also be achieved by heating the surface, paste, or combinations thereof.

In some embodiments, reacting the paste comprises cross-linking components within the paste. Cross-linking reactions can be intramolecular or intermolecular, and can also occur between a component and the substrate.

In some embodiments, reacting the paste comprises sintering metal particles present in the paste. Not being bound by any particular theory, sintering is a process in which metal particles join to form a continuous structure within a surface feature without melting. Sintering can be used to form both homogeneous and heterogeneous metal surface features.

In some embodiments, reacting comprises exposing a paste to a reaction initiator. Reaction initiators suitable for use with the present invention include, but are not limited to, thermal energy, electromagnetic radiation, acoustic waves, an oxidizing or reducing plasma, an electron beam, a stoichiometric chemical reagent, a catalytic chemical reagent, an oxidizing or reducing reactive gas, an acid or a base (e.g., a decrease or increase in pH), an increase or decrease in pressure, an alternating or direct electrical current, agitation, sonication, friction, and combinations thereof. In some embodiments, reacting comprises exposing a paste to multiple reaction initiators.

Electromagnetic radiation suitable for use as a reaction initiator can include, but is not limited to, microwave light, infrared light, visible light, ultraviolet light, x-rays, radiofrequency, and combinations thereof.

In some embodiments, a stamp or elastomeric stencil is removed from a substrate before reacting the paste. In some embodiments, a stamp or elastomeric stencil is removed from a substrate after reacting the paste.

In some embodiments, a method of the present invention further comprises: exposing an area of a substrate adjacent to a surface feature to a reactive component that reacts with the adjacent surface area, but which is unreactive towards the surface feature. For example, after producing a surface feature comprising a masking component, the substrate can be exposed to an etchant, such as a gaseous etchant, a liquid etchant, and combinations thereof.

In some embodiments, prior to applying a paste to a substrate, the substrate is patterned using a micro-contact printing method. For example, an ink can be applied to an elastomeric stamp having at least one indentation in the surface of the elastomeric stamp which defines a pattern, to form a coated elastomeric stamp, and the coated stamp is contacted with a substrate. The ink is transferred from the surface of the coated elastomeric stamp to the substrate in a pattern on the substrate defined by the pattern in the surface of the elastomeric stamp. The ink adheres to the surface, and can form at least one of a thin film, a monolayer, a bilayer, a self-assembled monolayer, and combinations thereof. In some embodiments the ink can react with the substrate. A paste is then applied to the substrate, wherein the paste is reactive towards either one of the exposed areas of the substrate or the areas of the substrate covered by the ink pattern screen printing, ink jet printing, syringe deposition, spraying, spin coating, brushing, and combinations thereof, and other application methods known to persons of ordinary skill in the art of coating surfaces. After reacting the paste, any residual paste and/or ink on the substrate can be removed. The resulting patterned substrate comprises a pattern having lateral dimensions that are determined by the pattern in the surface of the elastomeric stamp used to apply the ink to the substrate, as well as any patterns transferred to the substrate during the paste deposition process.

### EXAMPLES

### Example 1

An etching paste was prepared by adding a thickener (sodium carboxymethylcellulose, 1 g) to an 85% aqueous solution of H₃PO₄ (10 mL) with vigorous stirring (˜400 rpm), and the resulting mixture was vigorously stirred an additional 20-30 minutes.

The paste was poured onto an elastomeric stamp having indentations defining a pattern in the surface of the elastomeric stamp. The surface of the stamp was doctor bladed to ensure the indentations were filled uniformly with paste and to remove excess paste from the surface of the elastomeric stamp. The elastomeric stamp was then contacted with an aluminum surface, and the paste reacted with the surface for 5 minutes at room temperature. The stamp was then removed from the aluminum surface, and the surface was rinsed with deionized water and dried. Subtractive non-penetrating features were formed on the surface having lateral dimensions defined by the pattern in the surface of the elastomeric stamp.

### Example 2

The etching paste prepared in Example 1 is applied to a stamp having indentations defining a pattern by spin-coating (at about 100 rpm to about 5,000 rpm). The coated stamp is then contacted with an aluminum surface and the paste reacts for 5 minutes at room temperature. The stamp is removed from the aluminum surface, and the surface is rinsed with deionized water and dried. Subtractive non-penetrating features are formed on the aluminum surface having lateral dimensions defined by the pattern in the surface of the stamp.

### Example 3

An elastomeric stencil having openings defining a pattern is conformally contacted with an aluminum surface. The etching paste prepared in Example 1 is applied to the openings in the elastomeric stencil, and reacts with the aluminum surface for 5 minutes at room temperature. The elastomeric stencil is then removed from the aluminum surface, and the surface is rinsed with deionized water and dried. Subtractive non-penetrating surface features are formed on the aluminum surface having lateral dimensions defined by the lateral dimensions of the openings in the elastomeric stencil.

### Example 4

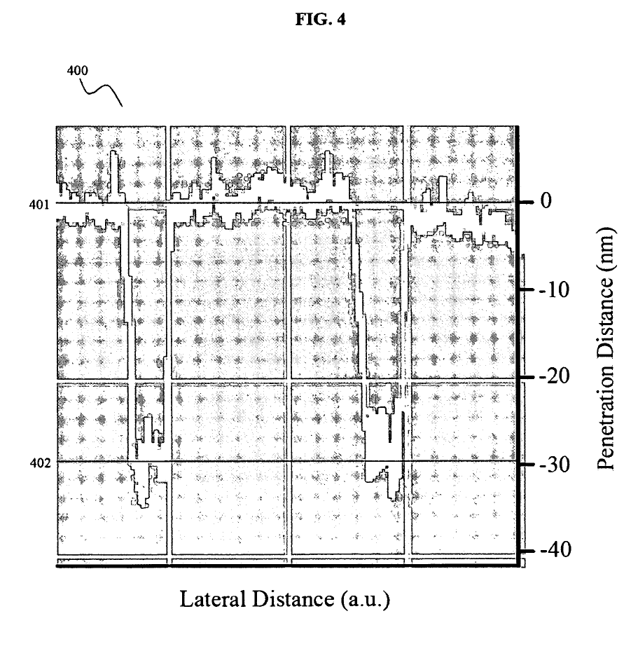

An elastomeric stencil having openings with lateral dimensions of 50 μm was conformally contacted with an ITO-on-glass surface (ITO thickness=30 nm). The etching paste prepared in Example 1 was applied to the openings in the elastomeric stencil. The paste was reacted with the ITO for 5 minutes at room temperature. The elastomeric stencil was then removed from the ITO-on-glass surface, and the surface was rinsed with deionized water and dried. Subtractive non-penetrating surface features were formed in the ITO, and are displayed in FIG. 3, FIG. 4 and FIG. 5.

Referring to FIG. 3, a visible microscopy image, 300, is provided of an ITO-on-glass substrate, 301, having a pattern of features thereon, 302. The surface features, 302, are rectangular trenches having lateral dimensions of about 80 μm by about 1.5 mm, and having a depth of about 30 nm. The dark image, 302, in the upper half of FIG. 3 is a profilometer probe, a reflection of which, 303, appears in the bottom half of the FIG. 3.

Referring to FIG. 4, a graphical representation of an elevation profile of the subtractive non-penetrating features on a glass slide, as shown in FIG. 3. The elevation profile was measured by scanning profilometry. The image shows that the distance between lines 401 and 402 is approximately 30 nm.

Referring to FIG. 5, a graphical representation, 500, of a lateral profile determined by optical profilometry of the subtractive non-penetrating features on an ITO-on-glass substrate, as shown in FIG. 3, is provided. The lateral profile shows the lateral dimensions of the surface features (as determined by the distance between lines 501 and 504) is about 80 μm. The indentations in the elastomeric stamp used to apply the paste to the substrate comprised indentations having lateral dimensions of about 50 μm. The lateral dimension of surface features at their deepest penetration into the substrate (as determined by the distance between lines 502 and 503) is about 60 μm. The portion of the surface feature between lines 501 and 502, and between lines 503 and 504, respectively, refers the undercut of the surface feature, which is about 10 μm.

### Example 5

An etching paste was prepared by dissolving potassium hydroxide (8 g) in deionized water (25 mL). A thickener (sodium carboxyethylcellulose, 2 g) was added with vigorous stirring (˜400 rpm), and the resulting mixture was stirred an additional 20-30 minutes.

The paste was poured onto an elastomeric stamp having indentations defining a pattern in the surface of the stamp. The surface of the stamp was doctor bladed to ensure the indentations were filled uniformly with paste and to remove excess paste from the surface of the elastomeric stamp. The elastomeric stamp was then contacted with a silicon surface and the paste reacted with the surface for 15 minutes at elevated temperature (100° C.). The stamp was then removed from the silicon surface, and the surface was rinsed with deionized water and dried. Subtractive non-penetrating features were formed on the surface having lateral dimensions defined by the pattern in the surface of the elastomeric stamp.

### Example 6

The etching paste prepared in Example 5 is applied to a stamp having indentations defining a pattern by spin-coating (at about 100 rpm to about 5,000 rpm). The coated stamp is then contacted with an silicon surface and the paste reacts for 5 minutes at room temperature. The stamp is removed from the silicon surface, and the surface is rinsed with deionized water and dried. Subtractive non-penetrating features are formed on the silicon surface having lateral dimensions defined by the pattern in the surface of the elastomeric stamp.

### Example 7

An elastomeric stencil having openings defining a pattern is conformally contacted with an silicon surface. The etching paste prepared in Example 5 is applied to the openings in the elastomeric stencil, and reacts with the silicon surface for 5 minutes at room temperature. The elastomeric stencil is then removed from the silicon surface, and the surface is rinsed with deionized water and dried. Subtractive non-penetrating surface features are formed in the silicon surface having lateral dimensions defined by the lateral dimensions of the openings in the elastomeric stencil.

### Example 8

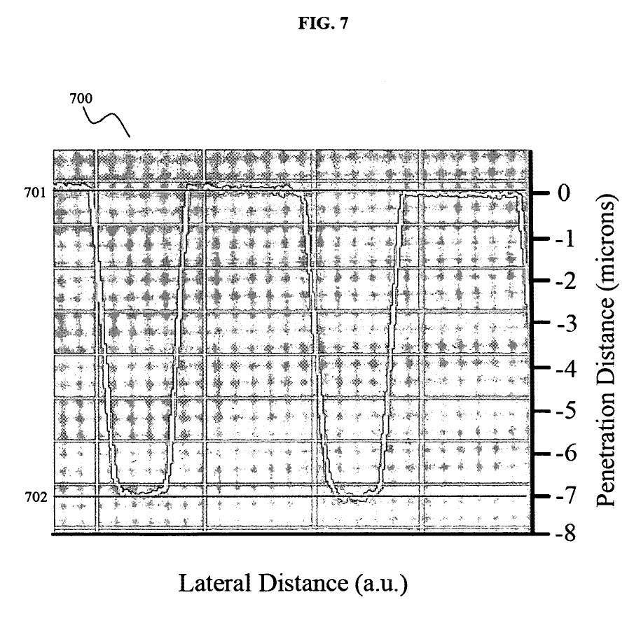

An elastomeric stencil having openings with lateral dimensions of 50 μm was pre-treated by exposure to an atmospheric plasma (approximately 78% N₂, 21% O₂ and 1% Ar) for 30 seconds (PDC-32G tabletop plasma cleaner, Harrick Plasma, Ithaca, N.Y.), which made the surface of the stamp hydrophilic. The pre-treated elastomeric stencil was conformally contacted with the surface of a glass microscope slide. An etching paste (ETCHALL®, B&B Products, Inc., Peoria, Ariz.) was diluted with deionized water (1:1 by volume), and then applied to the openings in the elastomeric stencil. The paste was reacted with the glass surface for 1 minute at room temperature. The elastomeric stencil was then removed from the glass surface, and the surface was rinsed with deionized water and dried. Subtractive non-penetrating surface features were formed in the glass surface, and are displayed in FIG. 6, FIG. 7 and FIG. 8.

Referring to FIG. 6, an image, 600, of a glass (SiO₂) substrate, 601, having subtractive non-penetrating surface features thereon, 602, produced by a method of the present invention is provided. The surface features are rectangular trenches having lateral dimensions of about 150 μm by about 0.5 mm, and having a depth of about 6.8 μm. The dark image in the upper portion of FIG. 6, 603, is a profilometer probe, a reflection off the substrate of which, 604, can be seen in the bottom half of the image.

Referring to FIG. 7, a graphical representation, 700, the elevation profile of the subtractive non-penetrating features on a glass (SiO₂) substrate, as shown in FIG. 6, is provided. The elevation profile was measured by scanning profilometry. The image, 700, shows that the penetration distance between the surface of the substrate, 701, and the bottom of the surface features, 702, is approximately 6.8 μm.

Referring to FIG. 8, a graphical representation, 800, of a lateral profile of the subtractive non-penetrating features on a glass slide, as shown in FIG. 6, as determined by optical profilometry. The lateral profile shows the lateral dimensions of the surface features (as determined by the distance between lines 801 and 804) is about 150 μm. The indentations in the elastomeric stamp used to apply the paste to the surface had indentations with lateral dimensions of about 50 μm. The lateral dimension of the base of the surface features (as determined by the distance between lines 802 and 803) is about 50 μm. The portion of the surface feature between lines 801 and 802 and between lines 803 and 804, respectively, is the undercut of the surface feature, which is about 50 μm.

### Example 9

A conductive paste is prepared by vigorously mixing silver particles (40% by weight) and a thickener (polyethylene oxide, 5% by weight) in water.

An elastomeric stencil having openings defining a pattern is conformally contacted with a glass (SiO₂) surface. The conductive paste is applied to the openings in the elastomeric stencil, and reacts with the glass surface for 2 minutes at elevated temperature (300° C.). The elastomeric stencil is then removed from the glass surface, and the surface is rinsed with deionized water and dried. Additive non-penetrating conductive surface features comprising silver are formed on the glass surface having lateral dimensions defined by the lateral dimensions of the openings in the elastomeric stencil.

### Example 10

A reactive paste comprising silica glass particles (SiO₂, 15% by weight), phosphoric acid (10% by weight), a thickener (polyvinylpyrrolidone, 5% by weight) and water is prepared by vigorously mixing the components.

The reactive paste is spin-coated onto a silicon surface (a silicon wafer). An elastomeric stamp having indentations defining a pattern in the surface of the stamp is pre-treated by exposing it to tridecafluoro-1,1,2,2-tetrahydrooctyltrichlorosilane to functionalize the surface of the stamp with fluorocarbon groups. This surface of the elastomeric stamp is contacted with the silicon surface and sufficient pressure or vacuum is applied to the backsides of the surface and the stamp to remove paste from between the surfaces of the stamp and the silicon that are contacting one another. Paste is present in the indentations of the stamp. The paste is then dried by heating the substrate (100° C.) for 10 minutes. The elastomeric stamp is then removed from the silicon surface, and the paste is reacted by heating the silicon surface (950° C.) for 20 minutes. The surface is cooled, and the paste is rinsed from the surface with water and sonication. Conformal penetrating semiconducting features (silicon n-doped with phosphorous) are formed on the silicon surface having lateral dimensions defined by the pattern in the elastomeric stamp.

### Example 11

A PDMS elastomeric stamp is exposed to an atmospheric plasma (approximately 78% N₂, 21% O₂ and 1% Ar) to make its surface hydrophilic. A reactive paste comprising silver nitrate (1.7 g), sodium carboxymethyl cellulose (8 g) and deionized water (100 mL) is poured onto the elastomeric stamp, and then doctor bladed to fill the indentations that define a pattern in the surface of the stamp, and to remove any excess paste from the surface of the elastomeric stamp. The surface of the elastomeric stamp is then contacted with a copper-coated surface at room temperature for 10 min. The stamp is then removed, and the substrate is washed with deionized water and dried. Conformal penetrating silver features are formed on the copper surface in the same pattern as that of the indentations in the elastomeric stamp.

### Example 12

A PDMS elastomeric stamp having indentations that define a pattern in its surface is exposed to an atmospheric plasma (approximately 78% N₂, 21% O₂ and 1% Ar) to make the surface of the elastomeric stamp hydrophilic. An paste comprising silicon dioxide particles (10% by weight) and a thickener (polylactic acid, 5% by weight) in water is poured onto the surface of the elastomeric stamp, and then doctor bladed to uniformly fill the indentations and remove any excess paste from the surface of the elastomeric stamp. The surface of the elastomeric stamp is then contacted with a metal surface. The metal surface is heated (˜100° C.) for 5 minutes, and the stamp is then removed from the metal surface. The SiO₂ features produced on the metal surface have lateral dimensions equivalent to the dimension of the indentations in the surface of the elastomeric stamp. The surface features can function, for example, as a mask for etching the metal surface, and/or as an insulating pattern on the metal surface.

### Example 13

A first etching paste suitable for producing subtractive features in a gold surface is prepared by mixing 4 g KI, 1 g I₂ and 40 mL H₂O with a 1 g of a thickener and mixing vigorously for 20-30 minutes. A second etching paste suitable for producing subtractive features in a gold surface is prepared by mixing 100 mL of an aqueous solution containing K₃Fe(CN)₆, (4 M), KCN (0.2 M) and KOH (0.1 M) with a thickener (1 g). The solution is mixed vigorously for 20-30 minutes.

An ink (hexadecane thiol) is coated onto the surface of an elastomeric stamp having an indentation that defines a pattern in its surface. The ink is dried, and the coated stamp is conformally contacted with a gold surface. The stamp is removed from the gold surface and a self-assembled monolayer of the hexadecane thiol is produced on the areas of the surface that are in conformal contact with the elastomeric stamp. Either the first or second etching paste prepared above is applied to the gold surface and reacted at room temperature for 10 minutes. The surface is then rinsed to remove the paste from the surface. Subtractive non-penetrating features are produced on the areas of the surface not covered by the self assembled monolayer.

### CONCLUSION

These examples illustrate possible embodiments of the present invention. While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

It is to be appreciated that the Detailed Description section, and not the Summary and Abstract sections, is intended to be used to interpret the claims. The Summary and Abstract sections can set forth one or more, but not all exemplary embodiments of the present invention as contemplated by the inventor(s), and thus, are not intended to limit the present invention and the appended claims in any way.

All documents cited herein, including journal articles or abstracts, published or corresponding U.S. or foreign patent applications, issued or foreign patents, or any other documents, are each entirely incorporated by reference herein, including all data, tables, figures, and text presented in the cited documents.

What is claimed is:

1. A method for forming a feature on a substrate, the method comprising:
(a) providing a stamp having a surface including at least one indentation therein, the indentation being contiguous with and defining a pattern in the surface of the stamp;
(b) applying a paste to the surface of the stamp to provide a coated stamp;
(c) contacting the surface of the coated stamp with a substrate to adhere the paste to an area of the substrate; and
(d) reacting the paste adhered to the area of the substrate to produce a feature on the substrate;
wherein the pattern on the surface of the stamp defines a lateral dimension of the surface feature, and
wherein the lateral dimension of the surface feature is about 40 nm to about 100 μm.

2. The method of claim 1, wherein the area of the surface onto which the paste is adhered is in contact with the surface of the stamp.

3. The method of claim 1, wherein the area of the substrate onto which the paste is adhered is in contact with the at least one indentation in the surface of the stamp.

4. The method of claim 1, further comprising: before reacting the paste, removing the stamp from the substrate.

5. The method of claim 1, further comprising: after reacting the paste, removing the stamp from the substrate.

6. The method of claim 1, further comprising pre-treating at least one of the stamp and the substrate with a process chosen from: cleaning, oxidizing, reducing, derivatizing, functionalizing, exposing to a reactive gas, exposing to a plasma, exposing to a thermal energy, exposing to an electromagnetic radiation, and combinations thereof.

7. The method of claim 1, wherein the surface feature is a subtractive non-penetrating surface feature.

8. A method for forming a feature on a substrate, the method comprising:
(a) evenly applying a paste to a substrate to form a coated substrate;
(b) providing a stamp having a surface including at least one indentation therein, the indentation being contiguous with and defining a pattern in the surface of the stamp;
(c) contacting the surface of the stamp with an area of the coated substrate to produce a pattern of paste on the substrate defined by the pattern in the surface of the stamp; and
(d) reacting the paste to produce a feature on the substrate;
wherein the pattern in the surface of the stamp defines a lateral dimension of surface feature, and
wherein the lateral dimension of the surface feature is about 40 nm to about 100 μm.

9. The method of claim 8, further comprising: before reacting the paste, removing the stamp from the substrate.

10. The method of claim 8, further comprising: after reacting the paste, removing the stamp from the substrate.

11. The method of claim 8, further comprising pre-treating at least one of the stamp and the substrate with a process chosen from: cleaning, oxidizing, reducing, derivatizing, functionalizing, exposing to a reactive gas, exposing to a plasma, exposing to a thermal energy, exposing to an electromagnetic radiation, and combinations thereof.

12. The method of claim 8, wherein the surface feature is a subtractive non-penetrating surface feature.

13. A method for forming a feature on a substrate, the method comprising:
(a) providing an elastomeric stencil having a surface with an opening therein;
(b) contacting the surface of the elastomeric stencil with a substrate, wherein the opening in the elastomeric stencil exposes an area of the substrate;
(c) applying a paste to the exposed area of the substrate; and
(d) reacting the paste applied to the exposed area of the substrate to produce a feature on the substrate;
wherein the lateral dimension of the opening in the elastomeric stencil defines a lateral dimension of the surface feature produced by reacting the paste, and
wherein the lateral dimension of the surface feature is about 40 nm to about 100 μm.

14. The method of claim 13, further comprising pre-treating at least one of the stamp and the substrate with a process chosen from: cleaning, oxidizing, reducing, derivatizing, functionalizing, exposing to a reactive gas, exposing to a plasma, exposing to a thermal energy, exposing to an electromagnetic radiation, and combinations thereof.

15. The method of claim 13, further comprising: before reacting the paste, removing the elastomeric stencil from the substrate.

16. The method of claim 13, further comprising: after reacting the paste, removing the elastomeric stencil from the substrate.

17. The method of claim 13, wherein the contacting comprises placing at least one area of the surface of the elastomeric stencil in conformal contact with at least one area of the substrate.

18. A method for forming a feature on a substrate, the method comprising:
(a) providing an elastomeric stamp having a surface including at least one indentation therein, the indentation being contiguous with and defining a pattern in the surface of the elastomeric stamp;
(b) applying an ink to the surface of the elastomeric stamp to form a coated elastomeric stamp;
(c) contacting the surface of the coated elastomeric stamp with a substrate for an amount of time sufficient to transfer the ink from the surface of the elastomeric stamp to an area of a substrate in a pattern defined by the pattern in the surface of the elastomeric stamp;
(c) removing the elastomeric stamp from the substrate;
(d) applying a paste to an area of the substrate not coated by the pattern of ink; and
(e) reacting the paste with the area of the substrate not coated by the pattern of ink to produce a feature on the substrate;
wherein the pattern of the ink defines a lateral dimension of the surface feature, and
wherein the lateral dimension of the surface feature is about 40 nm to about 100 μm.

19. The method of claim 18, wherein the contacting comprises placing at least one area of the surface of the elastomeric stamp in conformal contact with at least one area of the substrate.

20. The method of claim 18, wherein the surface feature is a subtractive non-penetrating surface feature.
